(19) United States
(12) Patent Application Publication
(10) Pub. No.: US 2025/0254574 A1
(43) Pub. Date: Aug. 7, 2025

(54) METHOD AND APPARATUS FOR SYNCHRONIZATION IN WIRELESS COMMUNICATION SYSTEM

(71) Applicant: Samsung Electronics Co., Ltd., Suwon-si (KR)

(72) Inventors: Jingxing FU, Beijing (CN); Feifei SUN, Beijing (CN); Zhe CHEN, Beijing (CN)

(21) Appl. No.: 19/039,102

(22) Filed: Jan. 28, 2025

(30) Foreign Application Priority Data
Feb. 4, 2024 (CN) 202410160785.2

(51) Int. Cl. H04W 36/00; H04W 36/06

(52) U.S. Cl. CPC H04W 36/0072; H04W 36/06

(57) ABSTRACT

The disclosure relates to a 5G or 6G communication system for supporting a higher data transmission rate. A method performed by a user equipment (UE) in a communication system is provided. The method includes transmitting, to a base station, a synchronization signal block (SSB) request including first information related to at least one serving cell of the UE associated with the SSB request; determining a first downlink bandwidth part (BWP) for detecting the SSB; and detecting the SSB on the first downlink BWP based on the first information.

### CROSS-REFERENCE TO RELATED APPLICATION(S)

This application is based on and claims priority under 35 U.S.C. § 119 (a) of a Chinese patent application number 202410160785.2, filed on Feb. 4, 2024, in the Chinese Intellectual Property Office, the disclosure of which is incorporated by reference herein in its entirety.

### BACKGROUND

### 1. Field

The disclosure relates to the field of communication. More particularly, the disclosure relates to a method and apparatus for synchronization in a wireless communication system.

### 2. Description of Related Art

5G mobile communication technologies define broad frequency bands such that high transmission rates and new services are possible, and can be implemented not only in “Sub 6 GHz” bands such as 3.5 GHz, but also in “Above 6 GHz” bands referred to as mmWave including 28 GHz and 39 GHz. In addition, it has been considered to implement 6G mobile communication technologies (referred to as Beyond 5G systems) in terahertz bands (for example, 95 GHz to 3 THz bands) in order to accomplish transmission rates fifty times faster than 5G mobile communication technologies and ultra-low latencies one-tenth of 5G mobile communication technologies.

At the beginning of the development of 5G mobile communication technologies, in order to support services and to satisfy performance requirements in connection with enhanced Mobile BroadBand (eMBB), Ultra Reliable Low Latency Communications (URLLC), and massive Machine-Type Communications (mMTC), there has been ongoing standardization regarding beamforming and massive MIMO for mitigating radio-wave path loss and increasing radio-wave transmission distances in mmWave, supporting numerologies (for example, operating multiple subcarrier spacings) for efficiently utilizing mmWave resources and dynamic operation of slot formats, initial access technologies for supporting multi-beam transmission and broadbands, definition and operation of BWP (BandWidth Part), new channel coding methods such as a LDPC (Low Density Parity Check) code for large amount of data transmission and a polar code for highly reliable transmission of control information, L2 pre-processing, and network slicing for providing a dedicated network specialized to a specific service.

Currently, there are ongoing discussions regarding improvement and performance enhancement of initial 5G mobile communication technologies in view of services to be supported by 5G mobile communication technologies, and there has been physical layer standardization regarding technologies such as V2X (Vehicle-to-everything) for aiding driving determination by autonomous vehicles based on information regarding positions and states of vehicles transmitted by the vehicles and for enhancing user convenience, NR-U (New Radio Unlicensed) aimed at system operations conforming to various regulation-related requirements in unlicensed bands, NR UE Power Saving, Non-Terrestrial Network (NTN) which is UE-satellite direct communication for providing coverage in an area in which communication with terrestrial networks is unavailable, and positioning.

Moreover, there has been ongoing standardization in air interface architecture/protocol regarding technologies such as Industrial Internet of Things (IIoT) for supporting new services through interworking and convergence with other industries, IAB (Integrated Access and Backhaul) for providing a node for network service area expansion by supporting a wireless backhaul link and an access link in an integrated manner, mobility enhancement including conditional handover and DAPS (Dual Active Protocol Stack) handover, and two-step random access for simplifying random access procedures (2-step RACH for NR). There also has been ongoing standardization in system architecture/service regarding a 5G baseline architecture (for example, service based architecture or service based interface) for combining Network Functions Virtualization (NFV) and Software-Defined Networking (SDN) technologies, and Mobile Edge Computing (MEC) for receiving services based on UE positions.

As 5G mobile communication systems are commercialized, connected devices that have been exponentially increasing will be connected to communication networks, and it is accordingly expected that enhanced functions and performances of 5G mobile communication systems and integrated operations of connected devices will be necessary. To this end, new research is scheduled in connection with extended Reality (XR) for efficiently supporting AR (Augmented Reality), VR (Virtual Reality), MR (Mixed Reality) and the like, 5G performance improvement and complexity reduction by utilizing Artificial Intelligence (AI) and Machine Learning (ML), AI service support, metaverse service support, and drone communication.

Furthermore, such development of 5G mobile communication systems will serve as a basis for developing not only new waveforms for providing coverage in terahertz bands of 6G mobile communication technologies, multi-antenna transmission technologies such as Full Dimensional MIMO (FD-MIMO), array antennas and large-scale antennas, metamaterial-based lenses and antennas for improving coverage of terahertz band signals, high-dimensional space multiplexing technology using OAM (Orbital Angular Momentum), and RIS (Reconfigurable Intelligent Surface), but also full-duplex technology for increasing frequency efficiency of 6G mobile communication technologies and improving system networks, AI-based communication technology for implementing system optimization by utilizing satellites and AI (Artificial Intelligence) from the design stage and internalizing end-to-end AI support functions, and next-generation distributed computing technology for implementing services at levels of complexity exceeding the limit of UE operation capability by utilizing ultra-high-performance communication and computing resources.

In order to meet the increasing demand for wireless data communication services since the deployment of fourth generation (4G) communication systems, efforts have been made to develop improved fifth generation (5G) or pre-5G communication systems. Therefore, 5G or pre-5G communication systems are also called “Beyond 4G networks” or “Post-long term evolution (LTE) systems”.

In order to achieve a higher data rate, 5G communication systems are implemented in higher frequency (millimeter wave (mmWave)) bands, e.g., 60 GHz bands. In order to reduce propagation loss of radio waves and increase a transmission distance, technologies such as beamforming, massive multiple-input multiple-output (MIMO), full-dimensional MIMO (FD-MIMO), array antenna, analog beamforming and large-scale antenna are discussed in 5G communication systems.

In addition, in 5G communication systems, developments of system network improvement are underway based on advanced small cell, cloud radio access network (RAN), ultra-dense network, device-to-device (D2D) communication, wireless backhaul, mobile network, cooperative communication, coordinated multi-points (CoMP), reception-end interference cancellation, etc.

In 5G systems, hybrid frequency shift keying (FSK) and quadrature amplitude modulation (QAM) (FQAM) and sliding window superposition coding (SWSC) as advanced coding modulation (ACM), and filter bank multicarrier (FBMC), non-orthogonal multiple access (NOMA) and sparse code multiple access (SCMA) as advanced access technologies have been developed.

The above information is presented as background information only to assist with an understanding of the disclosure. No determination has been made, and no assertion is made, as to whether any of the above might be applicable as prior art with regard to the disclosure.

### SUMMARY

Aspects of the disclosure are to address at least the above-mentioned problems and/or disadvantages and to provide at least the advantages described below. Accordingly, an aspect of the disclosure is to provide a method performed by a user equipment (UE), a method performed by a base station (BS), a UE or a BS.

Additional aspects will be set forth in part in the description which follows and, in part, will be apparent from the description, or may be learned by practice of the presented embodiments.

In accordance with an aspect of the disclosure, a method performed by a user equipment (UE) in a communication system is provided. The method includes transmitting, to a base station, a synchronization signal block (SSB) request including first information related to at least one serving cell of the UE associated with the SSB request; determining a first downlink bandwidth part (BWP) for detecting the SSB; and detecting the SSB on the first downlink BWP based on the first information.

In accordance with an aspect of the disclosure, a method performed by a base station in a communication system is provided. The method comprises receiving, from a user equipment (UE), a synchronization signal block (SSB) request including first information related to at least one serving cell of the UE associated with the SSB request; and transmitting, to the UE, the SSB based on the first information.

In accordance with an aspect of the disclosure, a user equipment (UE) is provided. The US includes a transceiver configured to transmit and receive signals with the outside; and a controller coupled to the transceiver and configured to transmit, to a base station, a synchronization signal block (SSB) request including first information related to at least one serving cell of the UE associated with the SSB request, determining a first downlink bandwidth part (BWP) for detecting the SSB, and detect the SSB on the first downlink BWP based on the first information.

In accordance with an aspect of the disclosure, a base station is provided. The base station includes a transceiver configured to transmit and receive signals with the outside; and a controller coupled to the transceiver and configured to receive, from a user equipment (UE), a synchronization signal block (SSB) request including first information related to at least one serving cell of the UE associated with the SSB request, and transmit, to the UE, the SSB based on the first information.

In accordance with an aspect of the disclosure, one or more non-transitory computer-readable storage media storing one or more programs including computer-executable instructions which, when executed by one or more processors of a user equipment (UE) individually or collectively, cause the UE to perform operations are provided. The operations include transmitting, to a base station, a synchronization signal block (SSB) request including first information related to at least one serving cell of the UE associated with the SSB request; determining a first downlink bandwidth part (BWP) for detecting the SSB; and detecting the SSB on the first downlink BWP based on the first information.

Other aspects, advantages, and salient features of the disclosure will become apparent to those skilled in the art from the following detailed description, which, taken in conjunction with the annexed drawings, discloses various embodiments of the disclosure.

### BRIEF DESCRIPTION OF THE DRAWINGS

The above and other aspects, features, and advantages of certain embodiments of the disclosure will be more apparent from the following description taken in conjunction with the accompanying drawings, in which:

FIG. 1 is a schematic diagram of the composition structure of various wireless networks according to an embodiment of the disclosure;

FIGS. 2A and 2B are schematic diagrams of wireless transmission and reception paths according to various embodiments of the disclosure;

FIG. 3A is a block diagram of a constituent structure of a user equipment according to an embodiment of the disclosure;

FIG. 3B is a block diagram of the composition structure of a base station according to an embodiment of the disclosure;

FIG. 4 illustrates a schematic diagram of a serving cell of a user equipment (UE) according to an embodiment of the disclosure;

FIG. 5 illustrates a flowchart of a method performed by a UE according to an embodiment of the disclosure;

FIG. 6 illustrates a schematic diagram of the relationship between bits included in an SSB request and serving cells according to an embodiment of the disclosure;

FIG. 7 illustrates a schematic diagram of the relationship between bits included in an SSB request and downlink BWPs of a serving cell according to an embodiment of the disclosure;

FIG. 8 illustrates a schematic diagram of the relationship between the time when the SSB request is transmitted and the time when the SSB is detected according to an embodiment of the disclosure;

FIG. 9 illustrates a structure of a user equipment (UE) according to an embodiment of the disclosure; and

FIG. 10 illustrates a structure of a base station according to an embodiment of the disclosure.

The same reference numerals are used to represent the same elements throughout the drawings.

### DETAILED DESCRIPTION

The following description with reference to the accompanying drawings is provided to assist in a comprehensive understanding of various embodiments of the disclosure as defined by the claims and their equivalents. It includes various specific details to assist in that understanding but these are to be regarded as merely exemplary. Accordingly, those of ordinary skill in the art will recognize that various changes and modifications of the various embodiments described herein can be made without departing from the scope and spirit of the disclosure. In addition, descriptions of well-known functions and constructions may be omitted for clarity and conciseness.

The terms and words used in the following description and claims are not limited to the bibliographical meanings, but, are merely used by the inventor to enable a clear and consistent understanding of the disclosure. Accordingly, it should be apparent to those skilled in the art that the following description of various embodiments of the disclosure is provided for illustration purpose only and not for the purpose of limiting the disclosure as defined by the appended claims and their equivalents.

It is to be understood that the singular forms “a,” “an,” and “the” include plural referents, unless the context clearly dictates otherwise. Thus, for example, reference to “a component surface” includes reference to one or more of such surfaces.

The term “include” or “may include” refers to the existence of a corresponding disclosed function, operation or component which can be used in various embodiments of the disclosure, and does not limit the existence of one or more additional functions, operations, or components. The terms “include” and/or “have” may be construed to represent certain characteristics, numbers, steps, operations, constituent elements, components or combinations thereof, but may not be construed to exclude the possibility of existence of one or more other characteristics, numbers, steps, operations, constituent elements, components or combinations thereof.

The term “or” used in various embodiments of the disclosure includes any of the listed terms or all combinations thereof. For example, “A or B” may include A, may include B, or may include both A and B.

Unless defined differently, all terms used in the disclosure, including technical or scientific terms, have the same meanings as those understood by the skilled in the art as described in the disclosure. Common terms as defined in a dictionary are to be interpreted to have meanings consistent with the context in the relevant technical field o, and are not to be interpreted ideally or excessively, unless clearly defined as such in the disclosure.

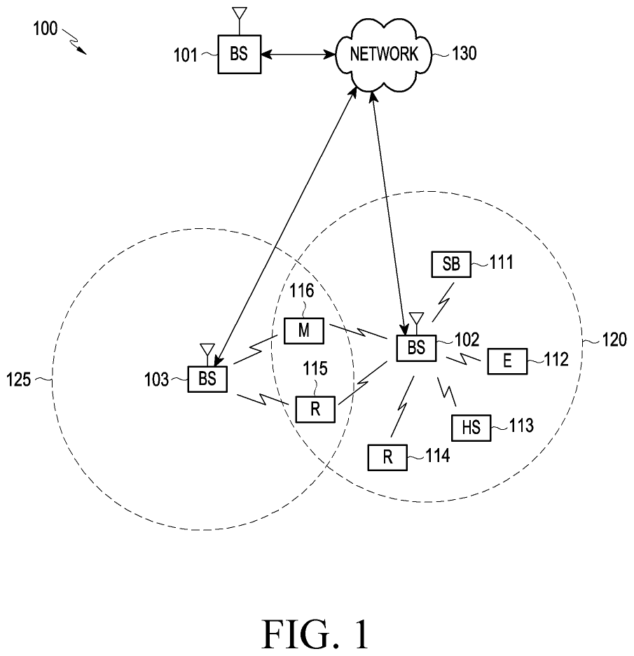

FIGS. 1, 2A, 2B, 3A, 3B, and 4 to 10 discussed below and various embodiments for describing the principle of the disclosure in this patent document are only for illustration, and should not be interpreted as limiting the scope of the disclosure in any way. Those skilled in the art will understand that the principle of the disclosure may be implemented in any suitably arranged system or device.

It should be appreciated that the blocks in each flowchart and combinations of the flowcharts may be performed by one or more computer programs which include instructions. The entirety of the one or more computer programs may be stored in a single memory device or the one or more computer programs may be divided with different portions stored in different multiple memory devices.

Any of the functions or operations described herein can be processed by one processor or a combination of processors. The one processor or the combination of processors is circuitry performing processing and includes circuitry like an application processor (AP, e.g. a central processing unit (CPU)), a communication processor (CP, e.g., a modem), a graphics processing unit (GPU), a neural processing unit (NPU) (e.g., an artificial intelligence (AI) chip), a Wi-Fi chip, a Bluetooth® chip, a global positioning system (GPS) chip, a near field communication (NFC) chip, connectivity chips, a sensor controller, a touch controller, a finger-print sensor controller, a display driver integrated circuit (IC), an audio CODEC chip, a universal serial bus (USB) controller, a camera controller, an image processing IC, a microprocessor unit (MPU), a system on chip (SoC), an IC, or the like.

FIG. 1 illustrates an example wireless network 100 according to an embodiment of the disclosure. The embodiment of the wireless network 100 shown in FIG. 1 is for illustration only. Other embodiments of the wireless network 100 can be used without departing from the scope of the disclosure.

The wireless network 100 includes a gNodeB (gNB) 101, a gNB 102, and a gNB 103. gNB 101 communicates with gNB 102 and gNB 103. gNB 101 also communicates with at least one Internet Protocol (IP) network 130, such as the Internet, a private IP network, or other data networks.

Depending on a type of the network, other well-known terms such as “base station” or “access point” can be used instead of “gNodeB” or “gNB”. For convenience, the terms “gNodeB” and “gNB” are used in this patent document to refer to network infrastructure components that provide wireless access for remote terminals. And, depending on the type of the network, other well-known terms such as “mobile station”, “user station”, “remote terminal”, “wireless terminal” or “user apparatus” can be used instead of “user equipment” or “UE”. For convenience, the terms “user equipment” and “UE” are used in this patent document to refer to remote wireless devices that wirelessly access the gNB, no matter whether the UE is a mobile device (such as a mobile phone or a smart phone) or a fixed device (such as a desktop computer or a vending machine).

gNB 102 provides wireless broadband access to the network 130 for a first plurality of User Equipments (UEs) within a coverage area 120 of gNB 102. The first plurality of UEs include a UE 111, which may be located in a Small Business (SB); a UE 112, which may be located in an enterprise (E); a UE 113, which may be located in a WiFi Hotspot (HS); a UE 114, which may be located in a first residence (R); a UE 115, which may be located in a second residence (R); a UE 116, which may be a mobile device (M), such as a cellular phone, a wireless laptop computer, a wireless personal digital assistant (PDA), etc. GNB 103 provides wireless broadband access to network 130 for a second plurality of UEs within a coverage area 125 of gNB 103. The second plurality of UEs include a UE 115 and a UE 116. In some embodiments, one or more of gNBs 101-103 can communicate with each other and with UEs 111-116 using 5G, Long Term Evolution (LTE), LTE advanced (LTE-A), worldwide interoperability for microwave access (WiMAX) or other advanced wireless communication technologies.

The dashed lines show approximate ranges of the coverage areas 120 and 125, and the ranges are shown as approximate circles merely for illustration and explanation purposes. It should be clearly understood that the coverage areas associated with the gNBs, such as the coverage areas 120 and 125, may have other shapes, including irregular shapes, depending on configurations of the gNBs and changes in the radio environment associated with natural obstacles and man-made obstacles.

As will be described in more detail below, one or more of gNB 101, gNB 102, and gNB 103 include a two-dimensional (2D) antenna array as described in embodiments of the disclosure. In some embodiments, one or more of gNB 101, gNB 102, and gNB 103 support codebook designs and structures for systems with 2D antenna arrays.

Although FIG. 1 illustrates an example of the wireless network 100, various changes can be made to FIG. 1. The wireless network 100 can include any number of gNBs and any number of UEs in any suitable arrangement, for example. Furthermore, gNB 101 can directly communicate with any number of UEs and provide wireless broadband access to the network 130 for those UEs. Similarly, each gNB 102-103 can directly communicate with the network 130 and provide direct wireless broadband access to the network 130 for the UEs. In addition, gNB 101, 102 and/or 103 can provide access to other or additional external networks, such as external telephone networks or other types of data networks.

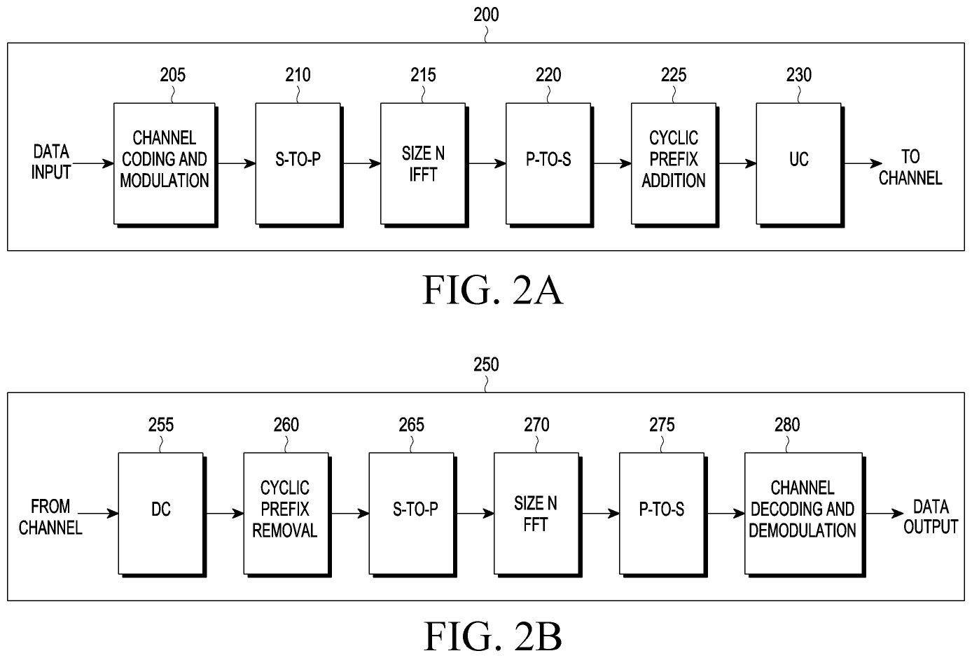

FIGS. 2A and 2B illustrate example wireless transmission and reception paths according to various embodiments of the disclosure. In the following description, the transmission path 200 can be described as being implemented in a gNB, such as gNB 102, and the reception path 250 can be described as being implemented in a UE, such as UE 116. However, it should be understood that the reception path 250 can be implemented in a gNB and the transmission path 200 can be implemented in a UE. In some embodiments, the reception path 250 is configured to support codebook designs and structures for systems with 2D antenna arrays as described in embodiments of the disclosure.

The transmission path 200 includes a channel coding and modulation block 205, a Serial-to-Parallel (S-to-P) block 210, a size N Inverse Fast Fourier Transform (IFFT) block 215, a Parallel-to-Serial (P-to-S) block 220, a cyclic prefix addition block 225, and an up-converter (UC) 230. The reception path 250 includes a down-converter (DC) 255, a cyclic prefix removal block 260, a Serial-to-Parallel (S-to-P) block 265, a size N Fast Fourier Transform (FFT) block 270, a Parallel-to-Serial (P-to-S) block 275, and a channel decoding and demodulation block 280.

In the transmission path 200, the channel coding and modulation block 205 receives a set of information bits, applies coding (such as Low Density Parity Check (LDPC) coding), and modulates the input bits (such as using Quadrature Phase Shift Keying (QPSK) or Quadrature Amplitude Modulation (QAM)) to generate a sequence of frequency-domain modulated symbols. The Serial-to-Parallel (S-to-P) block 210 converts (such as demultiplexes) serial modulated symbols into parallel data to generate N parallel symbol streams, where N is a size of the IFFT/FFT used in gNB 102 and UE 116. The size N IFFT block 215 performs IFFT operations on the N parallel symbol streams to generate a time-domain output signal. The Parallel-to-Serial block 220 converts (such as multiplexes) parallel time-domain output symbols from the Size N IFFT block 215 to generate a serial time-domain signal. The cyclic prefix addition block 225 inserts a cyclic prefix into the time-domain signal. The up-converter 230 modulates (such as up-converts) the output of the cyclic prefix addition block 225 to a radio frequency (RF) frequency for transmission via a wireless channel. The signal can also be filtered at a baseband before switching to the RF frequency.

The RF signal transmitted from gNB 102 arrives at UE 116 after passing through the wireless channel, and operations in reverse to those at gNB 102 are performed at UE 116. The down-converter 255 down-converts the received signal to a baseband frequency, and the cyclic prefix removal block 260 removes the cyclic prefix to generate a serial time-domain baseband signal. The Serial-to-Parallel block 265 converts the time-domain baseband signal into a parallel time-domain signal. The Size N FFT block 270 performs an FFT algorithm to generate N parallel frequency-domain signals. The Parallel-to-Serial block 275 converts the parallel frequency-domain signal into a sequence of modulated data symbols. The channel decoding and demodulation block 280 demodulates and decodes the modulated symbols to recover the original input data stream.

Each of gNBs 101-103 may implement a transmission path 200 similar to that for transmitting to UEs 111-116 in the downlink, and may implement a reception path 250 similar to that for receiving from UEs 111-116 in the uplink. Similarly, each of UEs 111-116 may implement a transmission path 200 for transmitting to gNBs 101-103 in the uplink, and may implement a reception path 250 for receiving from gNBs 101-103 in the downlink.

Each of the components in FIGS. 2A and 2B can be implemented using only hardware, or using a combination of hardware and software/firmware. As a specific example, at least some of the components in FIGS. 2A and 2B may be implemented in software, while other components may be implemented in configurable hardware or a combination of software and configurable hardware. For example, the FFT block 270 and IFFT block 215 may be implemented as configurable software algorithms, in which the value of the size N may be modified according to the implementation.

Furthermore, although described as using FFT and IFFT, this is only illustrative and should not be interpreted as limiting the scope of the disclosure. Other types of transforms can be used, such as Discrete Fourier transform (DFT) and Inverse Discrete Fourier Transform (IDFT) functions. It should be understood that for DFT and IDFT functions, the value of variable N may be any integer (such as 1, 2, 3, 4, etc.), while for FFT and IFFT functions, the value of variable N may be any integer which is a power of 2 (such as 1, 2, 4, 8, 16, etc.).

Although FIGS. 2A and 2B illustrate examples of wireless transmission and reception paths, various changes may be made to FIGS. 2A and 2B. For example, various components in FIGS. 2A and 2B can be combined, further subdivided or omitted, and additional components can be added according to specific requirements. Furthermore, FIGS. 2A and 2B are intended to illustrate examples of types of transmission and reception paths that can be used in a wireless network. Any other suitable architecture can be used to support wireless communication in a wireless network.

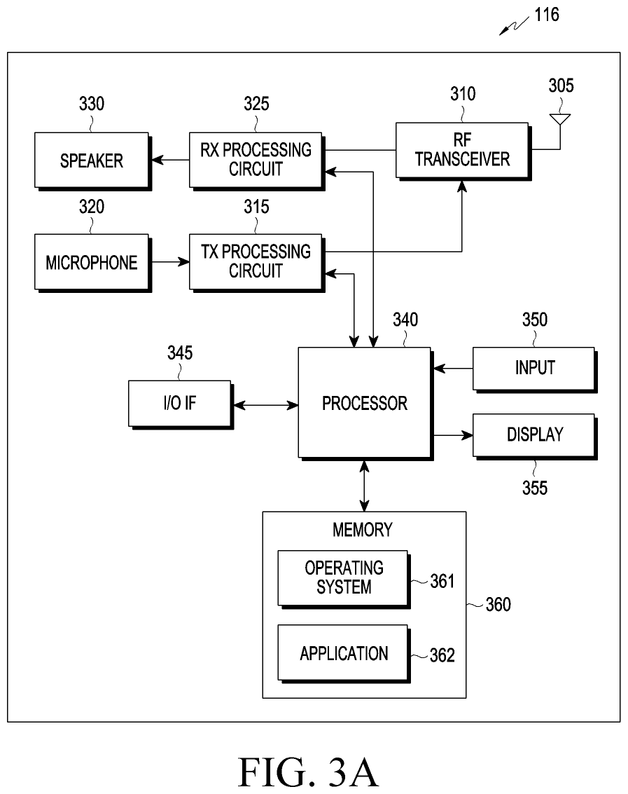

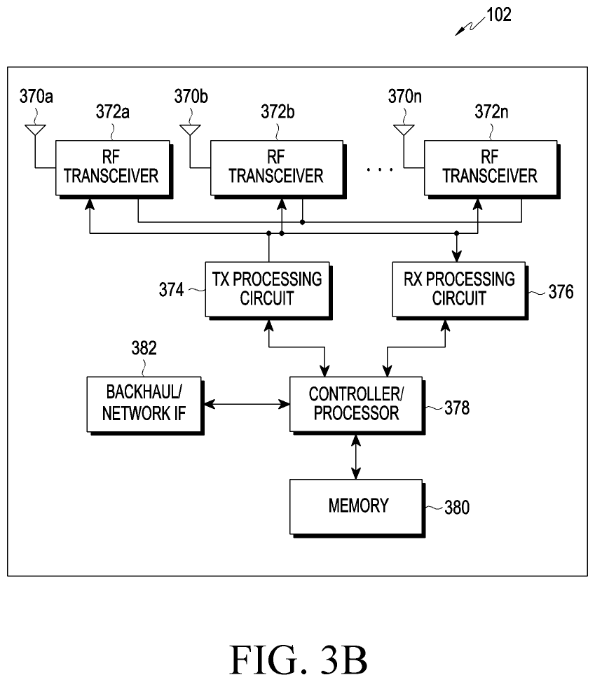

FIG. 3A illustrates an example UE 116 according to an embodiment of the disclosure. The embodiment of UE 116 shown in FIG. 3A is for illustration only, and UEs 111-115 of FIG. 1 can have the same or similar configuration. However, a UE has various configurations, and FIG. 3A does not limit the scope of the disclosure to any specific implementation of the UE.

UE 116 includes an antenna 305, a radio frequency (RF) transceiver 310, a transmission (TX) processing circuit 315, a microphone 320, and a reception (RX) processing circuit 325. UE 116 also includes a speaker 330, a processor/controller 340, an input/output (I/O) interface 345, an input device(s) 350, a display 355, and memory 360. The memory 360 includes an operating system (OS) 361 and one or more applications 362.

The RF transceiver 310 receives an incoming RF signal transmitted by a gNB of the wireless network 100 from the antenna 305. The RF transceiver 310 down-converts the incoming RF signal to generate an intermediate frequency (IF) or baseband signal. The IF or baseband signal is transmitted to the RX processing circuit 325, where the RX processing circuit 325 generates a processed baseband signal by filtering, decoding and/or digitizing the baseband or IF signal. The RX processing circuit 325 transmits the processed baseband signal to speaker 330 (such as for voice data) or to processor/controller 340 for further processing (such as for web browsing data).

The TX processing circuit 315 receives analog or digital voice data from microphone 320 or other outgoing baseband data (such as network data, email or interactive video game data) from processor/controller 340. The TX processing circuit 315 encodes, multiplexes, and/or digitizes the outgoing baseband data to generate a processed baseband or IF signal. The RF transceiver 310 receives the outgoing processed baseband or IF signal from the TX processing circuit 315 and up-converts the baseband or IF signal into an RF signal transmitted via the antenna 305.

The processor/controller 340 can include one or more processors or other processing devices and execute an OS 361 stored in the memory 360 in order to control the overall operation of UE 116. For example, the processor/controller 340 can control the reception of forward channel signals and the transmission of backward channel signals through the RF transceiver 310, the RX processing circuit 325 and the TX processing circuit 315 according to well-known principles. In some embodiments, the processor/controller 340 includes at least one microprocessor or microcontroller.

The processor/controller 340 is also capable of executing other processes and programs residing in the memory 360, such as operations for channel quality measurement and reporting for systems with 2D antenna arrays as described in embodiments of the disclosure. The processor/controller 340 can move data into or out of the memory 360 as required by an execution process. In some embodiments, the processor/controller 340 is configured to execute the application 362 based on the OS 361 or in response to signals received from the gNB or the operator. The processor/controller 340 is also coupled to an I/O interface 345, where the I/O interface 345 provides UE 116 with the ability to connect to other devices such as laptop computers and handheld computers. I/O interface 345 is a communication path between these accessories and the processor/controller 340.

The processor/controller 340 is also coupled to the input device(s) 350 and the display 355. An operator of UE 116 can input data into UE 116 using the input device(s) 350. The display 355 may be a liquid crystal display or other display capable of presenting text and/or at least limited graphics (such as from a website). The memory 360 is coupled to the processor/controller 340. A part of the memory 360 can include a random access memory (RAM), while another part of the memory 360 can include a flash memory or other read-only memory (ROM).

Although FIG. 3A illustrates an example of UE 116, various changes can be made to FIG. 3A. For example, various components in FIG. 3A can be combined, further subdivided or omitted, and additional components can be added according to specific requirements. As a specific example, the processor/controller 340 can be divided into a plurality of processors, such as one or more central processing units (CPUs) and one or more graphics processing units (GPUs). Furthermore, although FIG. 3A illustrates that the UE 116 is configured as a mobile phone or a smart phone, UEs can be configured to operate as other types of mobile or fixed devices.

FIG. 3B illustrates an example gNB 102 according to an embodiment of the disclosure. The embodiment of gNB 102 shown in FIG. 3B is for illustration only, and other gNBs of FIG. 1 can have the same or similar configuration. However, a gNB has various configurations, and FIG. 3B does not limit the scope of the disclosure to any specific implementation of a gNB. It should be noted that gNB 101 and gNB 103 can include the same or similar structures as gNB 102.

Referring to FIG. 3B, gNB 102 includes a plurality of antennas 370a-370n, a plurality of RF transceivers 372a-372n, a transmission (TX) processing circuit 374, and a reception (RX) processing circuit 376. In certain embodiments, one or more of the plurality of antennas 370a-370n include a 2D antenna array. gNB 102 also includes a controller/processor 378, memory 380, and a backhaul or network interface 382.

RF transceivers 372a-372n receive an incoming RF signal from antennas 370a-370n, such as a signal transmitted by UEs or other gNBs. RF transceivers 372a-372n down-convert the incoming RF signal to generate an IF or baseband signal. The IF or baseband signal is transmitted to the RX processing circuit 376, where the RX processing circuit 376 generates a processed baseband signal by filtering, decoding and/or digitizing the baseband or IF signal. RX processing circuit 376 transmits the processed baseband signal to controller/processor 378 for further processing.

The TX processing circuit 374 receives analog or digital data (such as voice data, network data, email or interactive video game data) from the controller/processor 378. TX processing circuit 374 encodes, multiplexes and/or digitizes outgoing baseband data to generate a processed baseband or IF signal. RF transceivers 372a-372n receive the outgoing processed baseband or IF signal from TX processing circuit 374 and up-convert the baseband or IF signal into an RF signal transmitted via antennas 370a-370n.

The controller/processor 378 can include one or more processors or other processing devices that control the overall operation of gNB 102. For example, the controller/processor 378 can control the reception of forward channel signals and the transmission of backward channel signals through the RF transceivers 372a-372n, the RX processing circuit 376 and the TX processing circuit 374 according to well-known principles. The controller/processor 378 can also support additional functions, such as higher-level wireless communication functions. For example, the controller/processor 378 can perform a Blind Interference Sensing (BIS) process such as that performed through a BIS algorithm, and decode a received signal from which an interference signal is subtracted. A controller/processor 378 may support any of a variety of other functions in gNB 102. In some embodiments, the controller/processor 378 includes at least one microprocessor or microcontroller.

The controller/processor 378 is also capable of executing programs and other processes residing in the memory 380, such as a basic OS. The controller/processor 378 can also support channel quality measurement and reporting for systems with 2D antenna arrays as described in embodiments of the disclosure. In some embodiments, the controller/processor 378 supports communication between entities such as web real-time communications (RTCs). The controller/processor 378 can move data into or out of the memory 380 as required by an execution process.

The controller/processor 378 is also coupled to the backhaul or network interface 382. The backhaul or network interface 382 allows gNB 102 to communicate with other devices or systems through a backhaul connection or through a network. The backhaul or network interface 382 can support communication over any suitable wired or wireless connection(s). For example, when gNB 102 is implemented as a part of a cellular communication system, such as a cellular communication system supporting 5G or new radio (NR) access technology or NR, LTE or LTE-A, the backhaul or network interface 382 can allow gNB 102 to communicate with other gNBs through wired or wireless backhaul connections. When gNB 102 is implemented as an access point, the backhaul or network interface 382 can allow gNB 102 to communicate with a larger network, such as the Internet, through a wired or wireless local area network or through a wired or wireless connection. The backhaul or network interface 382 includes any suitable structure that supports communication through a wired or wireless connection, such as an Ethernet or an RF transceiver.

The memory 380 is coupled to the controller/processor 378. A part of the memory 380 can include an RAM, while another part of the memory 380 can include a flash memory or other ROMs. In certain embodiments, a plurality of instructions, such as the BIS algorithm, are stored in the memory. The plurality of instructions is configured to cause the controller/processor 378 to execute the BIS process and decode the received signal after subtracting at least one interference signal determined by the BIS algorithm.

As will be described in more detail below, the transmission and reception paths of gNB 102 (implemented using RF transceivers 372a-372n, TX processing circuit 374 and/or RX processing circuit 376) support aggregated communication with frequency division duplex (FDD) cells and time division duplex (TDD) cells.

Although FIG. 3B illustrates an example of gNB 102, various changes may be made to FIG. 3B. For example, gNB 102 can include any number of each component shown in FIG. 3A. As a specific example, the access point can include many backhaul or network interfaces 382, and the controller/processor 378 can support routing functions to route data between different network addresses. As another specific example, although shown as including a single instance of the TX processing circuit 374 and a single instance of the RX processing circuit 376, gNB 102 can include multiple instances of each (such as one for each RF transceiver).

The various embodiments of the disclosure are further described below in conjunction with the accompanying drawings.

The text and drawings are provided as examples only to help readers understand the disclosure. They are not intended and should not be interpreted as limiting the scope of the disclosure in any way. Although certain embodiments and examples have been provided, based on the content disclosed herein, it is obvious to those skilled in the art that modifications to the illustrated embodiments and examples can be made without departing from the scope of the disclosure.

When the UE needs to access the system, it can detect the SSB (synchronization signal/Physical Broadcast Channel (PBCH) block) broadcast by the base station to realize downlink synchronization or perform access, etc. SSB may include primary synchronization signal (PSS), Secondary Synchronization Signal (SSS) and Physical Broadcast Channel (PBCH), and PBCH may include Demodulation Reference Signal (DMRS) for PBCH demodulation.

If the base station keeps transmitting SSB for UE to access the system or detect SSB during time-frequency synchronization, it may cause the base station to consume excess power.

Various embodiments of the disclosure provide a method performed by a user equipment (UE) in a communication system, comprising: transmitting a synchronization signal block (SSB) request to a base station, wherein the SSB request includes first information, the first information is related to at least one of one or more serving cells of the UE associated with the SSB request, or the first information is related to at least one of one or more bandwidth parts (BWP) of the one or more serving cells of the UE associated with the SSB request, or one or more configuration information for the SSB of the serving cells associated with the SSB request; determining a first downlink bandwidth part (BWP); detecting the SSB on the first downlink BWP.

Through the above method adopted by various implementations of the disclosure, the base station may not always send SSB, but when the UE needs to access the system or perform time-frequency synchronization, the UE sends a synchronization signal block (SSB) request to the base station to request the base station to send SSB, and the base station sends SSB in response to receiving the SSB request information, and after transmitting the synchronization signal block (SSB) request to the base station, the UE can timely determine the downlink BWP suitable for detecting SSB, so that the downlink BWP can be detected more timely.

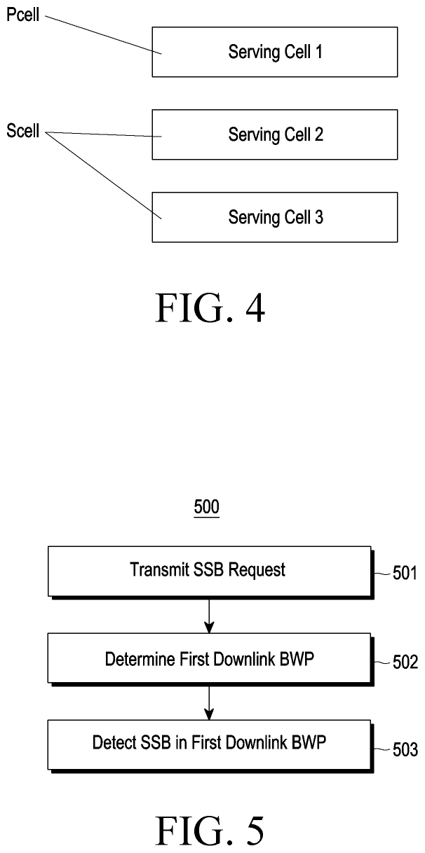

Various embodiments of the disclosure will be described in detail with reference to FIGS. 4 to 8.

In various embodiments of the disclosure, a UE may be configured with at least one serving cell, wherein one serving cell is called a primary cell (Pcell) and the remaining serving cells are called secondary cells (Scell). A serving cell may be called a Component Carrier (CC). Each serving cell can be configured with at least one downlink Bandwidth Part (BWP), and each serving cell has only one active downlink BWP at a certain moment, and the UE works on the active the downlink BWP. Among the downlink BWPs configured in one serving cell, some downlink BWPs are configured with SSB transmission, and some downlink BWPs are not configured with SSB transmission.

FIG. 4 illustrates a schematic diagram of a serving cell of a user equipment (UE) according to an embodiment of the disclosure.

Referring to FIG. 4, UE-1 is configured with three serving cells, namely, serving cell 1, serving cell 2 and serving cell 3, wherein serving cell 1 is Pcell, serving cell 2 and serving cell 3 are Scell.

FIG. 5 illustrates a flowchart of a method performed by a UE according to an embodiment of the disclosure. The method performed by the UE according to various embodiments of the disclosure may include one or more of operations S501 to S503.

In operation 501, a UE transmits an SSB request, wherein the SSB request includes first information, the first information is related to at least one of one or more serving cells of the UE associated with the SSB request, or the first information is related to at least one of one or more bandwidth parts (BWP) of the one or more serving cells of the UE associated with the SSB request, or one or more configuration information for the SSB of the serving cells associated with the SSB request.

In operation 502, the UE determines the first downlink BWP.

In operation 503, the UE detects (or monitors) SSB in the first downlink BWP.

With the above method, when the UE needs to access the system or perform time-frequency synchronization, the UE sends the synchronization signal block (SSB) request to the base station to request the base station to send the SSB, and the base station sends the SSB in response to receiving the first information included in the SSB request, so that the base station does not need to send the SSB all the time. And after transmitting a synchronization signal block (SSB) request to the base station, the UE can determine the downlink BWP suitable for detecting SSB, so that the downlink BWP can be detected.

Optionally, the method may further include receiving configuration information from the base station.

Optionally, the method may further include: in a case that the BWP where the UE is currently located is different from the first downlink BWP, the UE hands over to the first downlink BWP.

The method shown in FIG. 5 will be described in detail below.

According to one embodiment, in describing a wireless communication system and in the disclosure described below, a transfer method (or configuration method) of higher-layer signaling or higher-layer signal may be a signal transfer method for transferring information from a base station to a terminal through a downlink data channel of a physical layer or transferring information from a terminal to a base station through an uplink data channel of a physical layer, and examples of the signal transfer method may include a signal transmission method for transferring information through radio resource control (RRC) signaling, packet data convergence protocol (PDCP) signaling or medium access control (MAC) control element (CE).

In the description of the embodiment of the disclosure, the high-layer signaling may be a signaling corresponding to at least one or a combination of one or more of the following signaling.
master information block (MIB)
system information block (SIB) or SIB X (X=1, 2, . . . )
RRC signaling
MAC CE

The physical layer (Layer 1 (L1)) signaling may be a signaling corresponding to at least one or a combination of one or more of the following signaling.
physical downlink control channel (PDCCH)
downlink control information (DCI)
UE specific DCI
group common DCI
common DCI (e.g. multicast DCI)
scheduling DCI (for example, DCI for scheduling downlink or uplink data)
non-scheduled DCI (e.g., DCI other than DCI for scheduling downlink or uplink data)
physical uplink control channel (PUCCH)
uplink control information (UCI)
Paging
physical random access channel (PRACH)
random access response (RAR)

According to one embodiment, in operation 501, the configuration information received by the UE may include one or more of the following information:
information related to a serving cell configured with SSB transmission;
information related to a downlink BWP configured with SSB transmission;
information related to configuration of time-frequency resources of SSB transmission;
information related to a period of SSB transmission;
information related to a transmission duration of SSB transmission;
information related to a type of SSB transmission. The types of SSB can be, for example, Cell defined (CD)-SSB and non-cell defined (NCD)-SSB;
a first correspondence including one or more serving cells of the UE and one or more bandwidth parts (BWP) of the one or more serving cells; for example, the SSB request information value (also called, first information, index, bit value, identification, ID, etc., which will be further explained with examples later) is used to identify the serving cell in the first correspondence and its corresponding bandwidth part (BWP);
a second correspondence including one or more serving cells of the UE and configuration of one or more SSBs; for example, the SSB request information value (also called, first information, index, bit value, identification, ID, etc., which will be further explained with examples later) is used to identify the serving cell in the second correspondence and its corresponding SSB configuration;
a third correspondence including one or more serving cells of the UE, one or more bandwidth parts (BWP) of the one or more serving cells, and one or more configuration of SSB; for example, the SSB request information value (also called, first information, index, bit value, identification, ID, etc., which will be further explained with examples later) is used to identify the correspondence among the serving cell in the third correspondence, the bandwidth part BWP of the serving cell, and the configuration of SSB.

According to one embodiment, for example, the first SSB request may be an uplink reference signal, and the base station may configure the format, sequence, time-frequency resources, etc. of the uplink reference signal for SSB request, and the UE may receive the information through signaling when it is in a connected state, or the UE may determine the information through protocol preset. In this disclosure, the signaling can be system information, Higher-Layer Signaling, MAC Layer Signaling, physical layer signaling such as Downlink Control Signaling (DCI), and the like.

According to one embodiment, the SSB request can be sent through a random access channel, the base station can configure a preamble dedicated to the SSB request and send it to the UE through signaling, and the UE sends the SSB request through the random access channel according to the obtained preamble.

According to one embodiment, the SSB request may be Uplink Control Information (UCI), and the UE may request a new Secondary Cell (Scell) in a connected state, and sends UCI or MAC Control Element (CE) through a Primary Cell (Pcell). The UCI or MAC CE may contain K (K is a positive integer, and the UE can obtain K by receiving high-level signaling) bit request information (for example, the K bit request information can also be called the first information, index, bit value, identifier, ID, etc., or other names, and the disclosure is not limited to this). For example, every bit information value in the request information is “1”, which means that a specific serving cell (which can be one serving cell or more than one serving cell) has an SSB request, and “O” means that there is no SSB request in the specific serving cell.

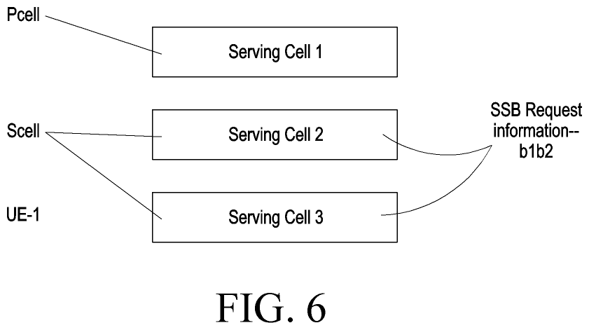

FIG. 6 illustrates a schematic diagram of the relationship between bits included in an SSB request and serving cells according to an embodiment of the disclosure.

Referring to FIG. 6, UE-1 receives Higher-layer signaling and is configured with three serving cells, namely, serving cell 1, serving cell 2 and serving cell 3, wherein serving cell 1 is Pcell, serving cell 2 and serving cell 3 are Scell. The SSB request information sent by the UE to the base station in Pcell includes 2 bits, namely b1b2, where the first bit b1 indicates whether the serving cell 2 has an SSB request and the second bit b2 indicates whether the serving cell 3 has an SSB request, and the correspondence between the SSB request information bits and whether the indicated serving cell has an SSB request can be obtained by the UE through receiving signaling. For example, if the value of b1 is “1”, it means that the serving cell 2 has an SSB request, and if the value of b1 is “0”, it means that the serving cell 2 has no SSB request. For another example, if the value of b2 is “1”, it means that the serving cell 3 has an SSB request, and if the value of b2 is “0”, it means that the serving cell 3 has no SSB request.

According to another embodiment, when the serving cell is configured with more than one downlink BWP, and among the downlink BWPs configured in one serving cell, some downlink BWPs are configured with SSB transmission, and some downlink BWPs are not configured with SSB transmission.

The UE receives signaling to obtain the configuration of the serving cell, the downlink BWP configuration and SSB configuration of each serving cell.

After transmitting SSB request information, it is also an urgent problem for UE to go to which downlink BWP in the serving cell to receive SSB and when to receive SSB.

### Example 1

In a case that the SSB request sent by the UE includes information indicating that the serving cell has an SSB request, after the UE sends the SSB request, the UE hands over to the downlink BWP of the serving cell that meets certain conditions to receive the SSB. In a case that the SSB request sent by the UE includes information indicating that the serving cell has no SSB request, the UE will not hand over to the downlink BWP of the serving cell that meets certain conditions to receive SSB.

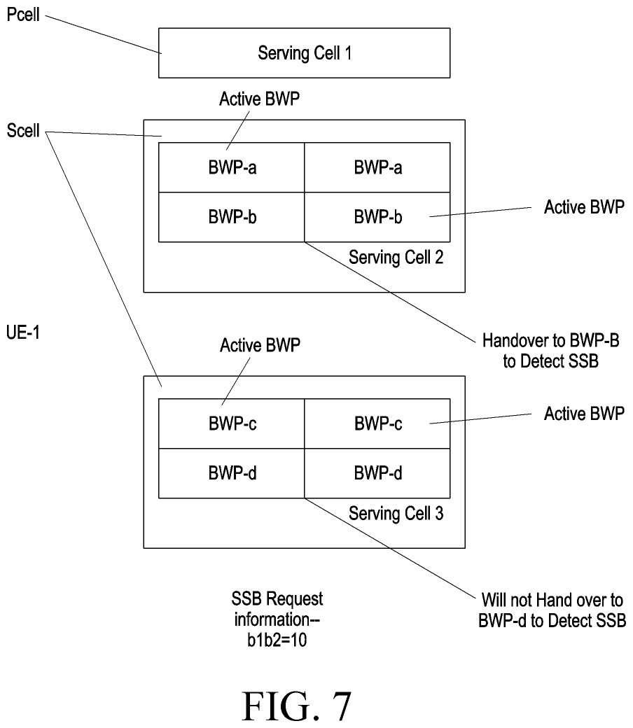

Referring to FIG. 7, FIG. 7 illustrates a schematic diagram of the relationship between bits included in an SSB request and downlink BWPs of a serving cell according to an embodiment of the disclosure.

Referring to FIG. 7, UE-1 is configured with three serving cells, namely, serving cell 1, serving cell 2 and serving cell 3, wherein serving cell 1 is Pcell, serving cell 2 and serving cell 3 are Scell. The SSB request sent by UE to the base station in Pcell includes 2 bits of b1b2, where the first bit b1 indicates whether there is an SSB request in the serving cell 2, for example, when b1 is 0, it indicates that serving cell 2 has no SSB request, and when b1 is 1, it indicates that serving cell 2 has an SSB request, and vice versa, which can be pre-configured or predefined. The second bit b2 indicates whether the serving cell 3 has an SSB request. For example, when b2 is 0, it indicates that the serving cell 3 has no SSB request, and when b1 is 1, it indicates that the serving cell 3 has an SSB request, and vice versa, which can be pre-configured or predefined.

As an example, when the value of b1b2 is “10”, there is an SSB request in serving cell 2 and there is no SSB request in serving cell 3. After transmitting the SSB request with b1b2 value of “10”, the UE hands over to downlink BWP-b (downlink BWP-b is the specific downlink BWP for receiving SSB in serving cell 2) in serving cell 2 to detect SSB, and the UE will not hand over to downlink BWP-d (downlink BWP-d is the specific downlink BWP for receiving SSB in serving cell 3) in serving cell 3.

### Example 2

In Example 2, the SSB request sent by the UE includes an indication of which downlink BWP of the serving cell has an SSB request, and the configuration of the downlink BWP of the serving cell requesting SSB.

For example, UE-1 is configured with three serving cells, namely, serving cell 1, serving cell 2 and serving cell 3, where serving cell 1 is Pcell, serving cell 2 and serving cell 3 are Scell. The SSB request information sent by the UE to the base station in the Pcell includes P bits (for example, the P bits can also be called the first information or other names, and this disclosure is not limited to this), the SSB request information value, the downlink BWP of the serving cell has an SSB request, and the configuration of the downlink BWP of the serving cell requesting SSB is shown in Table 1. Suppose P is equal to 3. For example, the SSB request information value is “001”, which means that the serving cell 1 has an SSB request, the UE goes to BWP-a in the serving cell 1 to receive the SSB, and receives the SSB according to the SSB configuration 2.

Table 1 illustrates the correspondence among the SSB request information value (which can also be called the first information, index, bit value, identification, ID, etc., and other names, and this disclosure is not limited to this) included in the SSB request sent by UE, the downlink BWP of the serving cell has an SSB request, and the configuration of the downlink BWP of the serving cell requesting SSB.

TABLE 1

| SSB request | | | |
|---|---|---|---|
| information | | | |
| value | Serving cell | BWP | Configuration of SSB |
| 000 | Serving cell 1 | BWP-a | SSB Configuration 1 |
| 001 | Serving cell 1 | BWP-a | SSB Configuration 2 |
| 010 | Serving cell 2 | BWP-b | SSB Configuration 1 |
| 011 | Serving cell 2 | BWP-b | SSB Configuration 2 |
| 100 | Serving cell 2 | BWP-c | SSB Configuration 1 |
| 101 | Serving cell 3 | BWP-d | SSB Configuration 1 |
| 110 | Serving cell 3 | BWP-e | SSB Configuration 1 |
| 111 | Serving cell 3 | BWP-f | SSB Configuration 1 |

It can be understood that Table 1 is only an example, and this disclosure also protects the case including a part of the above Table 1. For example, it may include the correspondence among the SSB request information value and one or more serving cells of the UE and one or more bandwidth parts BWP of one or more serving cells; it may also include the correspondence among the SSB request information value and one or more serving cells of the UE, the configuration of SSB, and so on.

### Example 3

When the information included in the SSB request sent by the UE indicates that the serving cell has an SSB request, the UE hands over to the downlink BWP of the serving cell that meets certain conditions to receive SSB.

The downlink BWP meeting certain conditions can be determined by the following method.

### Method 1:

When the serving cell is configured with a downlink BWP, the UE receives SSB at the downlink BWP.

### Method 2:

When the serving cell is configured with more than one downlink BWP and only one downlink BWP is configured with SSB transmission, the UE receives SSB in the downlink BWP configured with SSB transmission.

### Method 3:

When the serving cell is configured with more than one downlink BWPs, more than one downlink BWP is configured with SSB transmission, and there is an initial downlink BWP (initial DL BWP) in the serving cell, the UE receives SSB at the initial downlink BWP.

### Method 4:

When the serving cell is configured with more than one downlink BWP and more than one downlink BWP is configured with SSB transmission, and there is a default downlink BWP (the ID of the DL BWP can be defaultDownlinkBWP-Id) in the serving cell, the UE receives SSB at the default downlink BWP.

### Method 5:

When the serving cell is configured with more than one downlink BWP, and the UE receives signaling and configures one downlink BWP for receiving SSB transmission after the UE sends SSB request information, the UE receives SSB at the downlink BWP.

### Method 6:

When the serving cell is configured with more than one downlink BWP and more than one downlink BWP is configured with SSB transmission, the UE receives SSB in the downlink BWP with a small BWP ID or receives SSB in the downlink BWP with a large BWP ID.

### Method 7:

Among the above six methods, one method is selected to determine the downlink BWP for receiving SSB according to the configuration of downlink BWP and SSB, or according to the priority rule. For example, there is an initial downlink BWP and a default downlink BWP in the serving cell, and the UE receives SSB at the default downlink BWP. If there is an initial downlink BWP in the serving cell and there is no default downlink BWP, the UE receives SSB at the initial downlink BWP. According to other conditions or configurations, one method can be selected to determine the downlink BWP for receiving SSB and the configuration of receiving SSB to receive SSB.

### Example 4

In this disclosure, “time interval”, “time offset” and “time delay” are used interchangeably, meaning a period of time.

In this disclosure, a time unit is described by taking a time slot as an example, but it can be understood that the time unit is not limited to a time slot, but may include any one of a time slot, a sub-time slot or a symbol (e.g., orthogonal frequency division multiplexing (OFDM) symbol).

According to one embodiment, the UE may start to detect SSB after the first time interval S (the value of S may be greater than or equal to a threshold, Smax, Smax can be obtained by the UE's capability or determined by protocol preset) after the SSB request is sent.

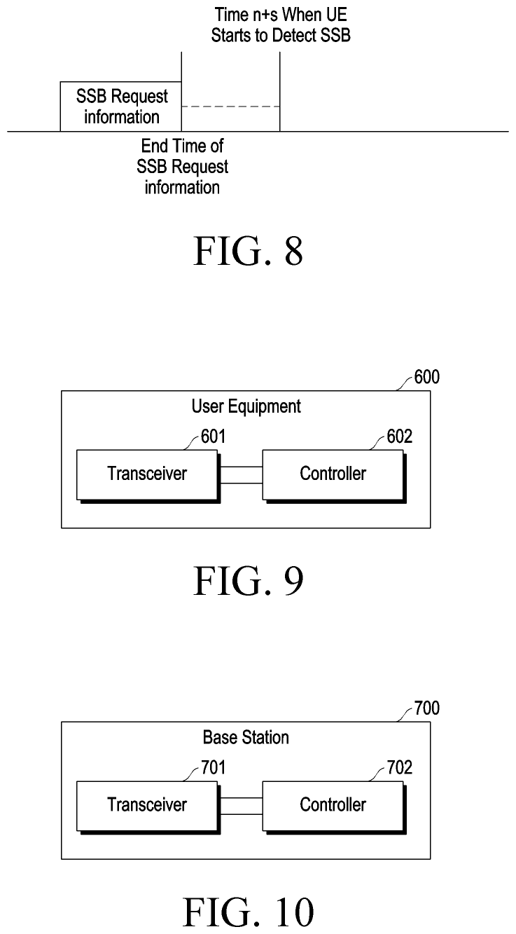

Referring to FIG. 8, FIG. 8 illustrates a schematic diagram of the relationship between the time when the SSB request is transmitted and the time when the SSB is detected according to an embodiment of the disclosure.

Referring to FIG. 8. According to one embodiment, the first time interval S may be obtained by receiving signaling (e.g., high layer signaling, media access layer signaling, physical layer signaling, etc.), or may be determined by protocol preset. The UE may receive the first time interval S through signaling when UE is in a connected state.

According to one embodiment, the first time interval may include the processing time for the base station to receive the SSB request and/or the preparation time for transmitting the SSB. In addition, the first time interval can be added with predefined time parameters on the basis of the processing time for the base station to receive the SSB request and/or the preparation time for transmitting the SSB, and this disclosure does not impose any restrictions on this.

According to one embodiment, after the UE sends the SSB request, the base station needs a processing time t1 to receive the SSB request, and after the base station successfully receives the SSB request, it needs a preparation time t2 to send the SSB before transmitting the SSB. It can be understood that the UE can determine the times t1 and t2 by receiving signaling (e.g., high layer signaling, media access layer signaling, physical layer signaling, etc.) or by protocol preset in the connected state, and then take the time offset t=t1+t2 as the time interval S between the end of SSB request transmission and the start of SSB detection by the UE. In this disclosure, the unit of time offset or time interval may be time slot, OFDM symbol, millisecond or microsecond.

According to one embodiment, if the active downlink BWP of the UE is not the downlink BWP for the UE to receive SSB, the UE should hand over to the downlink BWP for receiving SSB to receive SSB. The UE may hand over to a specific downlink BWP to receive SSB after the second time interval S1 (the value of S1 may be greater than or equal to a threshold, and S1max and S1max can be obtained by the UE's capability or determined by protocol preset) after the SSB request is sent. According to one embodiment, the second time interval S1 may be obtained by receiving signaling (e.g., high layer signaling, media access layer signaling, physical layer signaling, etc.), or may be determined by protocol preset. The UE may receive the second time interval S1 through signaling while the UE is in the connected state.

According to one embodiment, the second time interval S1 may be the same as the first time interval S, that is, the UE starts to detect SSB immediately after handing over to a specific downlink BWP.

According to one embodiment, the second time interval S1 may be independently configured from the first time interval S, that is, the time when the UE hands over to a specific downlink BWP and the time when UE starts detecting SSB may be different.

According to one embodiment, when the active downlink BWP is the downlink BWP for the UE to receive SSB, the first time interval S is L1, and when the active downlink BWP is not the downlink BWP for the UE to receive SSB, the first time interval S is L2, where L1 or L2 may be the same or different.

According to one embodiment, the first time interval and/or the second time interval may be configured or predefined by the base station.

Through the above method adopted by various implementations of the disclosure, the base station may not always send SSB, but when the UE needs to access the system or perform time-frequency synchronization, the UE sends a synchronization signal block (SSB) request to the base station to request the base station to send SSB, and the base station sends SSB in response to receiving the SSB request information, and after transmitting the synchronization signal block (SSB) request to the base station, the UE can timely determine the downlink BWP suitable for detecting SSB, so that the downlink BWP can be detected more timely.

In addition, it can be understood that the contents contained in each message in the above-mentioned embodiment are only examples of this disclosure, and the contents contained in various similar or identical messages can be replaced with each other, or named with different names, or some items can be added or deleted according to the situation, and for the sake of brevity, the meanings of similar content items can be mutually explained according to the context without being repeated, and the modified and explained embodiments still belong to the scope of protection of the disclosure.

FIG. 9 is a block diagram illustrating the structure of a user equipment 600 according to an embodiment of the disclosure.

Referring to FIG. 9, a user equipment 600 includes a transceiver 601 and a controller 602. The transceiver 601 is configured to transmit and receive signals to and from the outside. The controller 602 is configured to perform the method performed by the user equipment described above. The user equipment 600 may be implemented in the form of hardware, software, or a combination of hardware and software, so as to enable it to perform the method performed by the user equipment described in the disclosure.

FIG. 10 is a block diagram illustrating the structure of a base station 700 according to an embodiment of the disclosure.

Referring to FIG. 10, a base station 700 includes a transceiver 701 and a controller 702. The transceiver 701 is configured to transmit and receive signals to and from the outside. The controller 702 is configured to perform the method performed by the base station described above. The base station 700 may be implemented in the form of hardware, software, or a combination of hardware and software, so that it can perform the method described by the base station in this disclosure.

The disclosure can also be implemented as a computer storage medium. Computer instructions are stored in the computer storage medium. The computer instructions, when performed by a processor of a base station, cause the processor to perform one or more operations as described above in connection with specific embodiments, thereby realizing the method performed by the base station as described in the disclosure.

It can be understood that “at least one/at least one of” described in this disclosure includes any and/or all possible combinations of listed items, various embodiments described in this disclosure and various examples in embodiments can be changed and combined in any suitable form, and “/” described in this disclosure means “and/or”.

The illustrative logical blocks, modules, and circuits described in this disclosure may be implemented in or performed by a general-purpose processor, a Digital Signal Processor (DSP), an application specific integrated circuit (ASIC), Field Programmable Gate Array (FPGA) or other programmable logic devices, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices, such as a combination of a DSP and a microprocessor, multiple microprocessors, one or more microprocessors cooperating with a DSP core, or any other such configuration.

The steps of a method or algorithm described in this disclosure may be embodied directly in hardware, in a software module performed by a processor, or in a combination of the two. Software modules may reside in RAM memory, flash memory, ROM memory, erasable programmable ROM (EPROM) memory, electrically erasable programmable ROM (EEPROM) memory, registers, hard disks, removable disks, or any other form of storage media known in the art. A storage medium is coupled to a processor to enable the processor to read and write information from/to the storage medium. In the alternative, the storage medium may be integrated into the processor. The processor and storage medium may reside in an ASIC. The ASIC may reside in the user terminal. In the alternative, the processor and the storage medium may reside as separate components in the user terminal.

In one or more designs, the described functions may be implemented in hardware, software, firmware, or any combination thereof. If implemented in software, each function can be stored on or transmitted by a computer-readable medium as one or more instructions or codes. Computer-readable media include both computer storage media and communication media, and the latter includes any media that facilitates the transfer of computer programs from one place to another. The storage medium can be any available medium that can be accessed by a general-purpose or special-purpose computer.

The description set forth herein, taken in conjunction with the drawings, describes example configurations, methods and apparatus, and does not represent all examples that can be realized or are within the scope of the claims. As used herein, the term “example” means “serving as an example, instance or illustration” rather than “preferred” or “superior to other examples”. The detailed description includes specific details in order to provide an understanding of the described technology. However, these techniques may be practiced without these specific details. In some cases, well-known structures and devices are shown in block diagram form to avoid obscuring the concepts of the described examples.

Although this specification contains many specific implementation details, these should not be interpreted as limitations on any disclosure or the scope of the claimed protection, but as descriptions of specific features of specific embodiments of specific disclosures. Some features described in this specification in the context of separate embodiments can also be combined in a single embodiment. On the contrary, various features described in the context of a single embodiment can also be implemented separately in multiple embodiments or in any suitable sub-combination. Furthermore, although features may be described above as functioning in certain combinations, and even initially claimed as such, in some cases, one or more features from the claimed combination may be deleted from the combination, and the claimed combination may be directed to a subcombination or a variation of a subcombination.

It should be understood that the specific order or hierarchy of steps in the method of the disclosure is illustrative of a process. Based on the design preference, it can be understood that the specific order or hierarchy of steps in the method can be rearranged to realize the functions and effects disclosed in the disclosure. The appended method claims present elements of various steps in an example order, and are not meant to be limited to the particular order or hierarchy presented, unless otherwise specifically stated. Furthermore, although elements may be described or claimed in the singular, the plural is also contemplated unless the limitation on the singular is explicitly stated. Therefore, the disclosure is not limited to the illustrated examples, and any means for performing the functions described herein are included in various aspects of the disclosure.

It will be appreciated that various embodiments of the disclosure according to the claims and description in the specification can be realized in the form of hardware, software or a combination of hardware and software.

Any such software may be stored in non-transitory computer readable storage media. The non-transitory computer readable storage media store one or more computer programs (software modules), the one or more computer programs include computer-executable instructions that, when executed by one or more processors of an electronic device individually or collectively, cause the electronic device to perform a method of the disclosure.

Any such software may be stored in the form of volatile or non-volatile storage such as, for example, a storage device like read only memory (ROM), whether erasable or rewritable or not, or in the form of memory such as, for example, random access memory (RAM), memory chips, device or integrated circuits or on an optically or magnetically readable medium such as, for example, a compact disk (CD), digital versatile disc (DVD), magnetic disk or magnetic tape or the like. It will be appreciated that the storage devices and storage media are various embodiments of non-transitory machine-readable storage that are suitable for storing a computer program or computer programs comprising instructions that, when executed, implement various embodiments of the disclosure. Accordingly, various embodiments provide a program comprising code for implementing apparatus or a method as claimed in any one of the claims of this specification and a non-transitory machine-readable storage storing such a program.

While the disclosure has been shown and described with reference to various embodiments thereof, it will be understood by those skilled in the art that various changes in form and details may be made therein without departing from the spirit and scope of the disclosure as defined by the appended claims and their equivalents.

What is claimed is:

1. A method performed by a user equipment (UE) in a communication system, the method comprising:
transmitting, to a base station, a synchronization signal block (SSB) request including first information related to at least one serving cell of the UE associated with the SSB request;
determining a first downlink bandwidth part (BWP) for detecting the SSB; and
detecting the SSB on the first downlink BWP based on the first information.

2. The method of claim 1, wherein the first information includes at least one of information about the at least one serving cell, information about at least one BWP of the at least one serving cell, or configuration information for an SSB of the at least one serving cell.

3. The method of claim 1,
wherein the first information includes:
N bits, each bit corresponding to one serving cell of the UE, and being used to indicate whether the SSB request is used for a serving cell corresponding to the bit, or
each bit corresponding to a set of serving cells of the UE and being used to indicate whether the SSB request is used for all cells in the set of the serving cells corresponding to the bit, and
wherein N is greater than or equal to 1.

4. The method of claim 1, wherein the first information includes:
multiple bits, the multiple bits corresponding to one BWP of one serving cell of the UE and being used to indicate whether the UE performs an SSB request on a BWP corresponding to the bits and configuration of an SSB associated with the SSB request.

5. The method of claim 1,
wherein the first downlink BWP is determined by at least one of:
in a case that a serving cell of the UE is only configured with one downlink BWP, determining that the downlink BWP is the first downlink BWP;
in a case that the serving cell of the UE is configured with multiple downlink BWPs and only one downlink BWP is configured with SSB transmission, determining that the downlink BWP configured with SSB transmission is the first downlink BWP;
in a case that the serving cell is configured with multiple downlink BWPs, more than one downlink BWP is configured with SSB transmission, and the serving cell is configured with an initial downlink BWP, determining that the initial downlink BWP is the first downlink BWP;
in a case that the serving cell is configured with multiple downlink BWPs, more than one downlink BWP is configured with SSB transmission, and the serving cell is configured with a default downlink BWP, determining that the default downlink BWP is the first downlink BWP;
in a case that the serving cell is configured with multiple downlink BWPs, and the UE receives information or signaling related to configuring one downlink BWP for receiving SSB transmission after transmitting the SSB request, determining that the downlink BWP included in the signaling is the first downlink BWP; or
in a case that the serving cell is configured with multiple downlink BWPs and more than one downlink BWP is configured with SSB transmission, determining that the downlink BWP with a largest or smallest BWP identification (ID) is the first downlink BWP, and
wherein the first downlink BWP is determined based on a configuration on the downlink BWP, a configuration on the SSB, and/or a BWP priority rule.

6. The method of claim 1, further comprising:
in case that a BWP where the UE is currently located is different from the first downlink BWP, perform a hand over to the first downlink BWP.

7. The method of claim 1,
wherein the SSB is detected at the first downlink BWP after a first time interval from transmitting the SSB request, and
wherein the first time interval includes:
processing time for a base station to receive the SSB request, or
preparation time for transmitting the SSB.

8. The method of claim 6, wherein the hand over to the first downlink BWP occurs after a second time interval from transmitting the SSB request.

9. The method of claim 1, further comprising:
receiving configuration information from a base station,
wherein the configuration information includes at least one of:
information related to a serving cell configured with SSB transmission,
information related to a downlink BWP configured with SSB transmission,
information related to configuration of time-frequency resources of SSB transmission,
information related to a period of SSB transmission,
information related to a transmission duration of SSB transmission,
information related to a type of SSB transmission,
a first correspondence including one or more serving cells of the UE and one or more bandwidth parts (BWP) of the one or more serving cells,
a second correspondence including one or more serving cells of the UE and configuration of one or more SSBs, or
a third correspondence including one or more serving cells of the UE, one or more bandwidth parts (BWP) of the one or more serving cells, and one or more configuration of SSB.

10. The method of claim 1, wherein the SSB request is transmitted by at least one of:
an uplink reference signal;
a random access channel; or
uplink control information (UCI) or media access control (MAC) control element (CE).

11. A method performed by a base station in a communication system, the method comprising:
receiving, from a user equipment (UE), a synchronization signal block (SSB) request including first information related to at least one serving cell of the UE associated with the SSB request; and
transmitting, to the UE, the SSB based on the first information.

12. The method of claim 11, wherein the first information includes at least one of information about the at least one serving cell, information about at least one BWP of the at least one serving cell, or configuration information for an SSB of the at least one serving cell.

13. The method of claim 11,
wherein the first information includes:
N bits, each bit corresponding to one serving cell of the UE, and being used to indicate whether the SSB request is used for a serving cell corresponding to the bit, or
each bit corresponds to a set of serving cells of the UE and is used to indicate whether the SSB request is used for all cells in the set of the serving cells corresponding to the bit, and
wherein N is greater than or equal to 1.

14. The method of claim 11, wherein the first information comprises:
multiple bits, the multiple bits corresponding to one BWP of one serving cell of the UE and being used to indicate whether the UE performs an SSB request on a BWP corresponding to the bits and configuration of an SSB associated with the SSB request.

15. The method of claim 11, further comprising:
transmitting configuration information to the UE,
wherein the configuration information includes at least one of:
information related to a serving cell configured with SSB transmission,
information related to a downlink BWP configured with SSB transmission,
information related to configuration of time-frequency resources of SSB transmission,
information related to a period of SSB transmission,
information related to a transmission duration of SSB transmission,
information related to a type of SSB transmission,
a first correspondence including one or more serving cells of the UE and one or more bandwidth parts (BWPs) of the one or more serving cells,
a second correspondence including one or more serving cells of the UE and configuration of one or more SSBs, or
a third correspondence including one or more serving cells of the UE, one or more bandwidth parts (BWP) of the one or more serving cells, and one or more configuration of SSB.

16. The method of claim 11, wherein the SSB request is received by at least one of:
an uplink reference signal;
a random access channel; or
uplink control information (UCI) or media access control (MAC) control element (CE).

17. A user equipment (UE) in a communication system, the UE comprising:
a transceiver; and
at least one processor coupled to the transceiver and configured to:
transmit, to a base station, a synchronization signal block (SSB) request including first information related to at least one serving cell of the UE associated with the SSB request,
determine a first downlink bandwidth part (BWP) for detecting the SSB, and
detect the SSB on the first downlink BWP based on the first information.

18. The UE of claim 17, wherein the first information includes at least one of information about the at least one serving cell, information about at least one BWP of the at least one serving cell, or configuration information for an SSB of the at least one serving cell.

19. A base station in a communication system, the base station comprising:
a transceiver; and
at least one processor coupled with the transceiver and configured to:
receive, from a user equipment (UE), a synchronization signal block (SSB) request including first information related to at least one serving cell of the UE associated with the SSB request, and
transmit, to the UE, the SSB based on the first information.

20. The base station of claim 19, wherein the first information includes at least one of information about the at least one serving cell, information about at least one BWP of the at least one serving cell, or configuration information for an SSB of the at least one serving cell.
